(19) United States
(12) Patent Application Publication
(10) Pub. No.: US 2004/0188625 A1
(43) Pub. Date: Sep. 30, 2004

(54) Image detector for creating digital dental images

(75) Inventor: Ulrich Schulze-Ganzlin, Lorsch (DE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Sirona Dental Systems GmbH

(21) Appl. No.: 10/799,588

(22) Filed: Mar. 15, 2004

(30) Foreign Application Priority Data
Mar. 27, 2003 (DE) 103 13 976.1

(51) Int. Cl. G01T 1/24; H05G 1/64; G01T 1/166

(52) U.S. Cl. 250/370.09; 378/98.8

(57) ABSTRACT

The invention relates to an image for creating digital images. In the image detector there are present means for receiving and storing administrative data.

### TECHNICAL FIELD

The invention relates to an image detector for creating digital dental images, particularly adapted to receive X-rays. Such image detectors are also known as radiation detectors.

### BACKGROUND OF THE INVENTION

DE 44 02 114 A1 discloses a radiation detector having a housing to accommodate a radiation transformer, which converts impinging radiation, particularly X-ray radiation, to electric signals. This radiation detector is cordless and means are provided for inputting energy and for outputting the signals.

WO 02 41 783 A1 discloses an X-ray sensor which is likewise used for making intraoral images. This sensor is connected to a computer by a cable and is operated via the computer.

A disadvantage of this is that to control the sensor it is necessary to keep an eye on the display unit of the computer.

Schick offers a cordless sensor having a state indicator comprising an LED and an actuating element. In this case it is possible to know if the unit is ready for operation after it has been placed in the mouth of the patient, but the sensor is out of view during actual imaging and a display of information is provided only on the computer associated with the sensor.

### SUMMARY OF THE INVENTION

According to the invention, an image detector for creating digital dental images is provided which comprises means for receiving and storing administrative data.

The invention defined in claim 1 has the advantage that the allocation of images created by the image detector to the administrative data can be readily verified.

Advantageously, means are provided for displaying the administrative data. Display means provided directly on the radiation detector (image detector) itself ensure that the display is in the line of sight of the user responsible for steering the radiation detector. This is particularly advantageous when the space available for positioning the sensor is restricted, as is the case when creating intraoral images.

While imaging is being carried out, the image detector is here again out of view and the computer monitor again offers still more information under these circumstances. But prior to and after making the actual series of images, i.e., when the sensor is not totally hidden from view in the mouth, it is possible to provide a display of information on the image detector itself.

Furthermore, means for transmitting administrative data or image data can be provided.

In addition to the display there may be provided an actuating element, for example a key, for switching the sensor on or off.

According to a further development, an energy storage device is present to supply energy to the storage device and/or to the display device.

The image detector is advantageously of cordless design.

Finally, a storage area can be provided for storing the signals produced by the X-rays. This storage area can be a digital memory device, and means for transforming the signals produced by the X-rays to digital signals can be provided.

### BRIEF DESCRIPTION OF THE DRAWINGS

The drawings illustrate an embodiment of the invention in which:

FIG. 1 shows a system for creating a dental X-ray image in the form of an intraoral image,

FIGS. 2a, 2b show a first embodiment of the image detector, and

FIGS. 3a, 3b show a second embodiment of the image detector.

### EXAMPLE

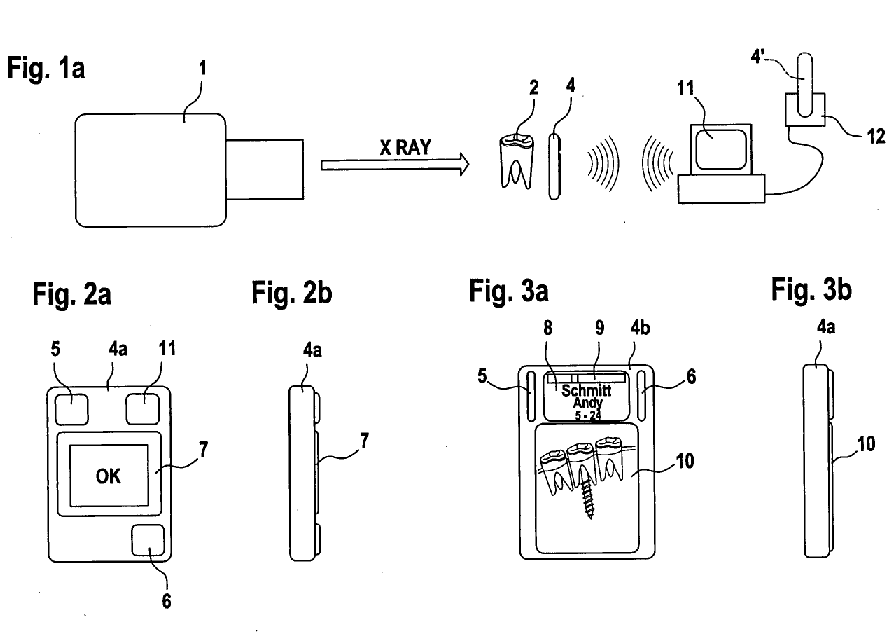

An X-ray unit 1 illustrated in FIG. 1, here shown pointing to an object to be X-rayed, in this case tooth No. 2, emits X-rays which are received by an X-ray-sensitive image detector and converted to digital data. These data are transmitted to a remote work station 11 by radio communication. In addition, a docking station 12 connected to the work station 11 via a cable can be provided for charging the image detector 4 and/or for establishing a wireless connection, which ensures errorless transmission between the image detector 4 and the docking station 12 itself.

FIGS. 2a and 2b illustrate a first embodiment of the image detector 4.

The image detector 4a has on its side remote from the X-rays a first key 5 for switching the image detector on and off. To avoid faulty operation, a second key 6 is provided for unlocking the first key.

Above this there is provided an alphanumeric display 7 for displaying the administrative data or information on the state of operation. For example, the remaining stand-by time, the number of images stored, the number of images still to be created, the quality of exposure of the previous image, the name of the patient, or the condition of the battery can be displayed.

Furthermore, a light 11 in the form of an LED can be provided, which can be an indication of the readiness for exposure, for example, making itself optically noticeable by changing colors between green and red or by blinking at different frequencies.

Means (not shown) for receiving and storing administrative data are present in the image detector 4. There are also present means (not shown) for transmitting image data, an energy storage device (not shown), and storage means (not shown) for storing the signals produced by the X-rays.

FIG. 2b illustrates the image detector in side view so that the components illustrated in FIG. 2a are clearly visible on the rear side of the radiation detector. Alternatively, the light 11 could, for example, be disposed in the lateral face shown in said drawing.

FIG. 3a shows another embodiment of the image detector 4b. In addition to an alphanumeric display 8 there is provided a bar graph display 9 for indicating the condition of the battery. Furthermore, a display 10 for a preview image of the radiographed image is provided, by means of which it is possible to check at least the area covered by the radiographed image and to ascertain whether the desired object is included in the area subjected to radiation.

In addition there are actuating elements 5, 6 which, by reason of the high space requirements of the preview display, are disposed on both sides of the alphanumeric display 8.

FIG. 3b illustrates the image detector 4b in side view and shows that the display for the preview image covers a large portion of the rear side of the image detector 4b.

In the case of cordless image detectors, such as is shown in the present embodiment, there can arise a situation, differing from the use of cord-connected image detectors, where the energy storage device is insufficiently charged to produce a complete X-ray image. In particular, it is advantageous when the user can directly check the state of charge of the energy storage device on the image detector itself.

However, the function of the display is, according to the invention, mainly to provide administrative information, such as the name of the patient, the job number, or the number of images (still) to be created, which information is transmitted via software from the computer to the image detector.

Of course, the display can however also supply state information concerning, for example, the connection between transmitter and receiver—“Connect to Receiver”—, the battery, or the number of remaining images, which information will then come exclusively from the image detector itself.

The following course of events might well take place in a large practice or in a hospital:

Job data are transmitted to the sensor present in a docking station or connected thereto for cordless transmission of signals. The assistant fetches the image detector from a central storeroom or from a docking station. The advantage of central storage resides not only in protection from theft but also, inter alia, in the fact that the image detector is always freshly charged with energy and can at this stage be provided with the information associated with each job.

The data relating to the job and the patient are now displayed on the image detector itself, these data being part of the administrative data relating to the X-ray job. This also serves to establish correct coupling of image detector and patient.

The assistant takes the patient to an arbitrary X-ray. The X-ray station comprises a suitable X-ray apparatus and a computer-assisted work station equipped with a monitor for the X-ray image, which monitor is connected through a data network to the administration or a data base. The assistant checks out the patient against the administrative data stored in the image detector or transmitted by the image detector to the X-ray station, as, for example, the name of the patient, and activates the image detector. When the image detector outputs a signal “Operating State in Order”, this is indicated on the sensor and/or on the X-ray monitor. This information is transferred from the image detector to the remote work station.

Following this identification, the monitor displays all other administrative information received, for example, via an internal network from the administration and/or a data base or derived from data transmitted from the image detector, and may also display individual state information concerning the sensor.

The assistant takes a series of radiographs and receives acknowledgement through the monitor, for example, by the display of a control picture and information concerning the current state of the sensor.

When the series of radiographs has been taken, the patient is dismissed and the assistant returns the sensor to the central storeroom or puts it back into the docking station.

The use of the sensor without the transfer of job data is as follows. In this case, no job data are transferred to, or displayed by, the sensor.

The sensor is fetched by the assistant, and the assistant takes the patient to an arbitrary X-ray station. The X-ray station comprises suitable X-ray apparatus and a computer-assisted work station comprising an X-ray monitor connected via a data network to the administration. The assistant looks for the respective job sheet at the work station and logs in the patient. In this way the patient is also correctly entered. The sensor is then activated. When a state message comes from the sensor with the signal “Operating State in Order”, this will be displayed on the sensor and/or on the X-ray monitor and the assistant will take a series of radiographs. A control picture is then shown on the monitor as well as information on the current state of the sensor. When the series of radiographs has been taken, the patient is dismissed, and the assistant returns the sensor to the central storeroom or puts it back into the docking station of the work station.

Unlocking the sensor to produce or cancel a state of readiness for exposure can take place in different ways.

A suitable unlocking mechanism comprises, for example, activation of the sensor only when it is at the X-ray station and without any additional key on the sensor. For reasons of design this is a great advantage, as the space available is small. When the sensor is taken from the docking station, which need not be connected to the X-ray station, it is in a search mode looking for a “Connect” to produce a connection. Only when the sensor is in the reception zone of an X-ray station can a connection be established. The user then activates the sensor at the X-ray station by a suitable action, and the sensor sends an acknowledgement of said activation to the X-ray station. In addition, this state can be made visible by a display on the sensor. Cancellation of the activation takes place either after creating each image or by an action at the X-ray station.

Activation may also be effected by simultaneous depression of two keys on the sensor or by prolonged depression of a single key on the sensor, whilst only brief depression thereof will trigger some other function.

Alternatively, a combination of actuation of a sensor key and activation at the X-ray station is possible.

Finally, a component can be built into the sensor, for example a responder, which activates an alarm device when the sensor passes through a certain area. This is an effective way of preventing theft.

What is claimed is:

1. An image detector for creating digital dental images, comprising means for receiving and storing administrative data.

2. An image detector as defined in claim 1, further comprising means for displaying administrative data.

3. An image detector as defined in claim 1, further comprising means for transmitting administrative data.

4. An image detector as defined in claim 3, further comprising means for transmitting image data.

5. An image detector as defined in claim 1, further comprising an actuating element.

6. An image detector as defined in claim 2, further comprising an energy storage device for supplying energy to the displaying means.

7. An image detector as defined in claim 1, further comprising a storage device for signals produced by X-rays is provided.

8. An image detector as defined in claim 7, wherein the storage device is a digital memory and that means for transforming the signals produced by the X-rays to digital signals are provided.

9. An image detector as defined in claim 1, further comprising a display showing the condition of the image detector.
